(19) United States
(12) Patent Application Publication
(10) Pub. No.: US 2018/0093206 A1
(43) Pub. Date: Apr. 5, 2018

(54) APPARATUS USING AN AIR FAN TO SEPARATE SOLIDS SUSPENDED IN A FLUID MEDIUM

(71) Applicant: Ismail Sukru BOSTANCI, Istanbul (TR)

(72) Inventor: Ismail Sukru BOSTANCI, Istanbul (TR)

(21) Appl. No.: 15/567,083

(22) PCT Filed: Apr. 11, 2016
(86) PCT No.: PCT/TR2016/050105

§ 371 Date: Oct. 17, 2017

(30) Foreign Application Priority Data
Apr. 29, 2015 (GB) 1507278.8

(51) Int. Cl. B01D 21/00; B01D 21/28

(52) U.S. Cl. CPC B01D 21/0087; B01D 47/027; B01D 2247/04; B01D 21/28

(57) ABSTRACT

An apparatus adapted to separate solids suspended in a fluid medium, includes a cylindrical container adapted to contain the fluid medium, an air movement fan operatively connected to the container, the fan being positioned to direct a flow or flows of air onto the surface of the fluid medium at a tangent to the axis of the container, thereby to generate a swirling movement of the fluid around the axis, whereby the solids congregate around the axis from the fluid medium.

### CROSS REFERENCE TO RELATED APPLICATIONS

This application is the national phase entry of International Application No. PCT/TR2016/050105, filed on Apr. 11, 2016, which is based upon and claims priority to Turkey Patent Application No. 1507278.8, filed on Apr. 29, 2015, the entire contents of which are incorporated herein by reference.

### TECHNICAL FIELD

The present invention relates to apparatus adapted to separate suspended solids from a fluid medium utilising an air flow.

### BACKGROUND OF THE INVENTION

It is a well-known phenomena that if a liquid such as water is contained in a substantially cylindrical container and the water is swirled around in a circular direction about the axis of the container, any solids suspended in the liquid tend to gravitate towards the axis of the container where they settle in the bottom of the container. The present invention seeks to use this phenomena to separate suspended solids from a liquid medium.

### SUMMARY OF THE INVENTION

According to the present invention there is provided apparatus adapted to separate solids suspended in a fluid medium, including:

a substantially cylindrical container (1) adapted to contain the said fluid medium, an air movement fan (6) operatively connected to said container (1), the fan (6) being positioned to generate a flow or flows of air onto the surface of the fluid medium generally at a tangent to the axis (7) of the container (1), thereby to generate swirling movement of the fluid about the axis (7) whereby said solids congregate about the axis (7) from where they are removable from the fluid medium.

Preferably, the said flow or flows of air are drawn across the surface of the fluid medium, and in a preferred arrangement, an air guide arrangement is provided to direct the air flow in the desired direction.

In a preferred embodiment, the fan (6) is an axial fan having its axis of rotation co-axial with the axis (7) of the container (1), and further, the fan (6) may be incorporated in a lid or cover (4) for the container (1).

In this embodiment, the lid (4) preferably incorporates a plurality of openings (9) disposed about the lid (4) at or adjacent to the periphery to enable air to be drawn into the container (1).

Preferably, the container (1) has a fluid medium outlet (2) and means to maintain the level of the fluid medium surface at a predetermined level.

In a further embodiment, the apparatus may incorporate an extraction device to remove the solid matter from the fluid whilst the fluid medium is in circulation.

A preferred embodiment of the invention will now be described by way of example, with reference to the accompanying drawings of the present invention.

### BRIEF DESCRIPTION OF THE DRAWINGS

FIG. 1 shows a container for a liquid medium with a cover incorporating a fan,

FIG. 2 shows a schematic view of the underside of the cover,

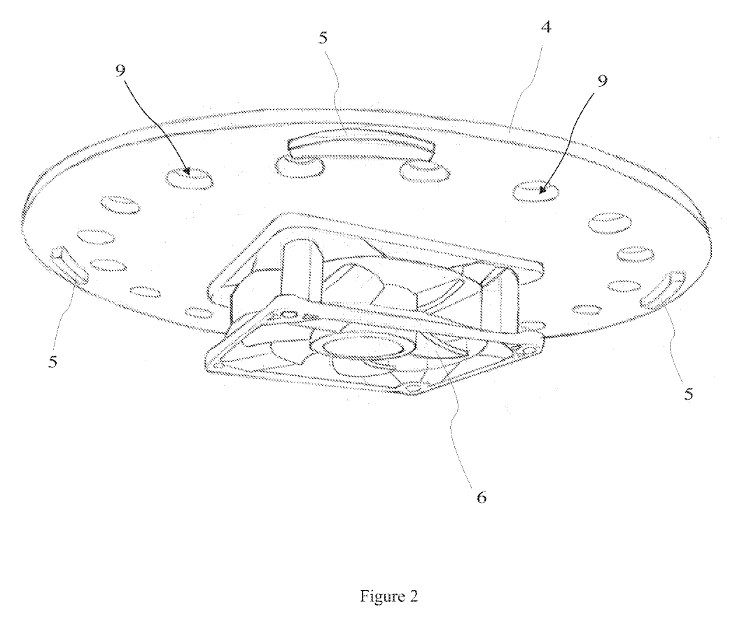

FIG. 3 shows a plan view of the underside of the cover, and

FIG. 4 shows a view corresponding to FIG. 1 illustrating the airflow through the device.

### DETAILED DESCRIPTION OF THE INVENTION

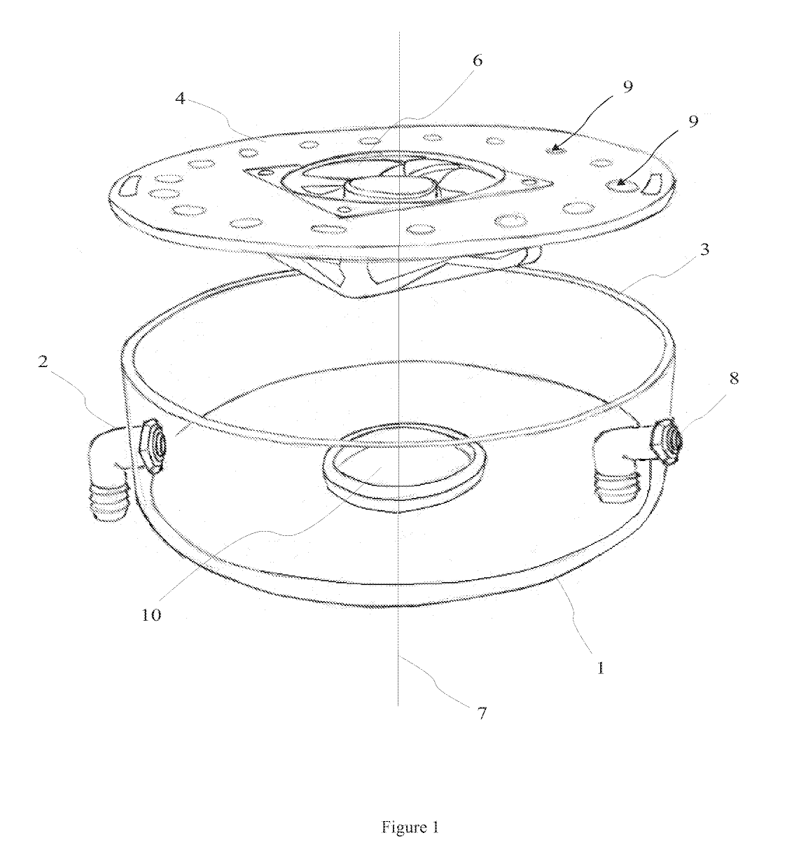

Referring now to FIG. 1, there is shown a generally cylindrical container (1) having an open top (3) which is adapted to receive a fluid or liquid medium such as water in which solids are suspended. The container (1) has an outlet (2) which serves to maintain the liquid in the container (1) at a predetermined level. The fluid medium may be poured into the open top (3) of the container (1), but preferably has an inlet pipe (8) entering the side of the container. The inlet pipe (8) may incorporate a shut off valve, which may be responsive to the height of the fluid medium in the container (1), to control the ingress of fluid medium

The open top (3) of the container (1) is closed by a cover (4) which is secured to the container (1) by means of a twist lock mechanism (5) to close the container (1). The cover (4) incorporates an axial fan (6) which is rotatably mounted so as to be rotatable about the axis (7) of the container (1) to draw an air flow through the container (1). The cover (4) has a plurality of air inlet openings (9) disposed equidistantly about the cover (4) at or adjacent to the periphery thereof.

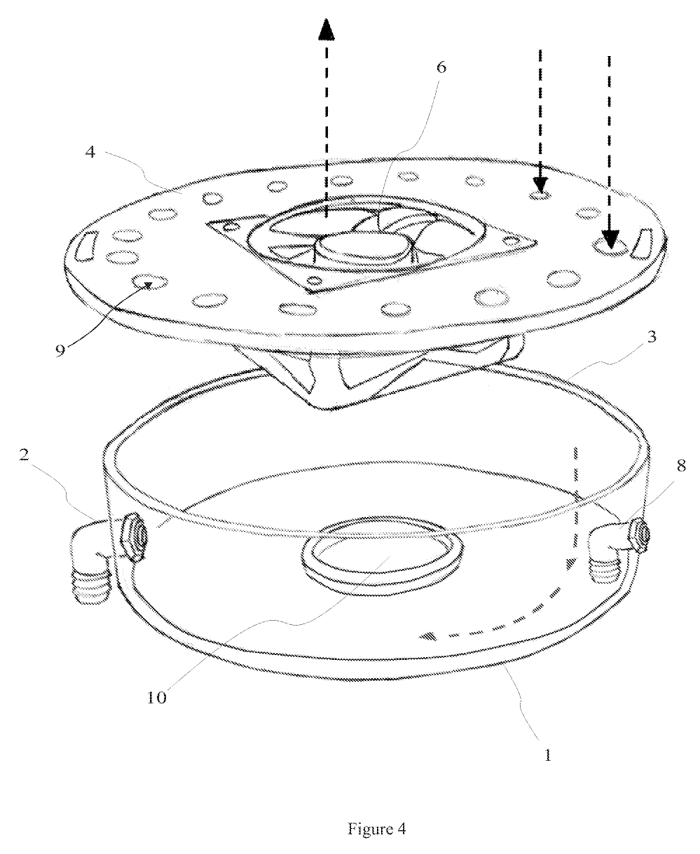

As shown in FIG. 4, the fan (6) creates an air flow or flows by drawing air into the container (1) through the openings (9) extracting air from the container (1) to create a spiral flow of air passing across the surface of the liquid in the container (1) on a generally tangential path. The air flow or flows impinge on the surface of the liquid from in a generally tangential direction. The air flow thus causes the liquid to swirl about the axis (7) of the container (1). By and generating the air flow in this manner, the maximum effect of the air flow on the liquid is achieved.

As the liquid swirls around the container (1) in a circular direction the suspended solids gradually are moved towards the axial centre of the container (1) to congregate about the axis (7) where they sink slowly down to the bottom of the container (1). As shown, the bottom of the container (1) has a well or recess (10) to aid the conglomeration of the solids.

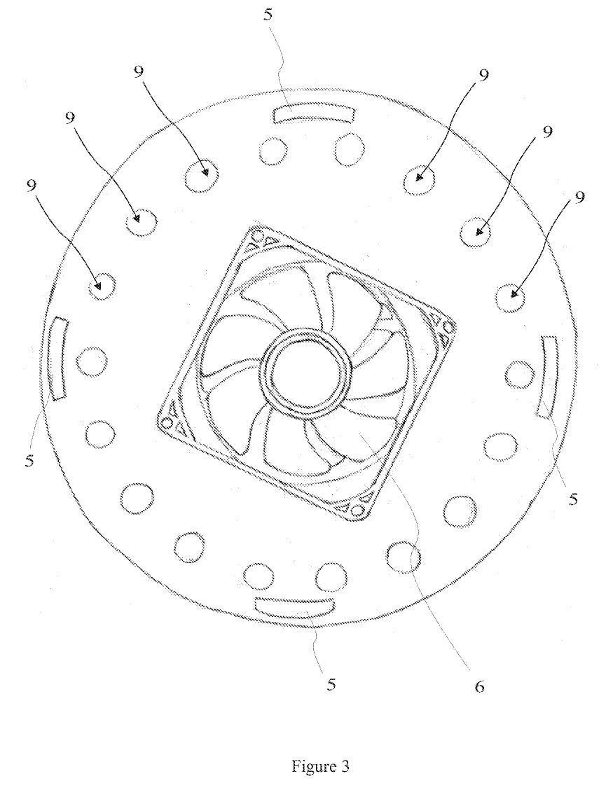

Referring now to FIG. 3 there is shown a plan view of the underside of the cover (4) showing the twist lock fasteners (5) and the centrally located fan (6). There are a plurality of air openings disposed equidistantly about the container (1) at or towards the periphery of the cover (4) which serve to enable air to be drawn into the container (1) by the fan (6). The plurality of the openings provided serve to allow the air to be drawn uniformly from around the lid to try to minimise any localised pressure differences in the container (1).

In the particular embodiment described, the fans' (6) revolutionary speed is 1800 rpm and the diameter of the fan (6) blades is 80 mm. In another embodiment the fan (6) diameter is 120 mm and is designed to rotate at 800 rpm The diameter of the container (1) is typically 20 cm and its height is 5 cm. The water level within the container (1) is maintained at approximately 9-10 mm and the fan (6) blades are located 1.5 cm above the water surface. Many different sizes of container (1) may be provided with appropriate size fans (6) depending upon the nature of the fluid medium and the solid matter is to be separated out. Although the embodiments described are not large, it is possible for the apparatus to be scaled up to many times the size disclosed.

Although not shown, it is possible for the apparatus to have means to automatically withdraw the agglomerated solids from the central well (10) in the container (1) and also to provide means to ensure a continual supply of fluid medium to the container (1) to provide a continuous removal of solids from the liquid medium.

What we claimed is:

1. An apparatus to separate solids suspended in a fluid medium, comprising
a cylindrical container to contain the fluid medium,
air movement fan operatively connected and positioned to the container to generate a flow or flows of air across the surface of the fluid medium at a tangent to an axis of the container, wherein a swirling movement of the fluid around the axis is generated and the suspended solids are congregated around the axis from the fluid medium.

2. The apparatus according to claim h wherein the air movement fan is an axial fan having an axis of rotation co-axial with the axis of the container.

3. The apparatus according to claim wherein the air movement fan creates the air flow or flows impinging on the surface of the liquid from in a tangential direction.

4. The apparatus according to claim wherein the air movement fan further comprising a cover for the container.

5. The apparatus according to claim 1, wherein the apparatus further comprising an air guide arrangement to direct the air flow or flows onto the fluid medium in a predetermined direction.

6. The apparatus according to claim 5, wherein the air guide arrangement is a plurality of air inlet openings disposed to the cover at or adjacent to the periphery thereof to enable air to be drawn into the container.

7. The apparatus according to claim 1, wherein the container comprising has a fluid medium outlet for maintaining the level of the fluid medium surface at a predetermined level.

8. The apparatus according to claim 1, wherein the container further comprising a well or recess to aid the conglomeration and removal of the solids suspended in a fluid medium.
